(19) United States
(12) Patent Application Publication
(10) Pub. No.: US 2003/0164380 A1
(43) Pub. Date: Sep. 4, 2003

(54) Packaging system for separately storing and dispensing together separate medication components

(76) Inventors: Rajneesh Taneja, Libertyville, IL (US); Pramod Gupta, Gurnee, IL (US)

Correspondence Address: STEVEN F. WEINSTOCK, ABBOTT LABORATORIES, 100 ABBOTT PARK ROAD, DEPT. 377/AP6A, ABBOTT PARK, IL, 60064-6008, US

(21) Appl. No.: 10/322,988

(22) Filed: Dec. 18, 2002

Related U.S. Application Data
(60) Provisional application No. 60/341,937, filed on Dec. 19, 2001.

(51) Int. Cl. G07F 11/00

(52) U.S. Cl. 221/76

(57) ABSTRACT

The present invention relates to a package system intended to simplify the usage of multiple medications stored separately and used together, thereby minimize the non-compliant use of the multiple medications. Generally, the separate medication components are contained in a plurality of cavities, arranged in one or more arcs or concentric circles. The package system further includes an access shield having one or more openings, which are selectively aligned in one of a plurality of positions, corresponding to the per use groupings. When the one or more openings in an access shield are aligned with the cavities corresponding to one of the per use groupings, the medication components are capable of being released from their respective cavities. Conversely, the shield substantially restricts access to the medication components located in the non-aligned cavities.

This application claims priority from U.S. Provisional Application Serial No. 60/341,937, filed Dec. 19, 2001.

### FIELD OF THE INVENTION

The invention pertains to a packaging system for separately storing and dispensing together separate medication components. More specifically, the invention pertains to a package which includes a plurality of cavities for receiving multiple medication components organized into per use groupings. The package further includes an access shield having one or more openings, which selectively provides access to the cavities containing the medication components for one of the per use groupings.

### BACKGROUND OF THE INVENTION

Noncompliance with prescription medications has been identified as a major health care concern in the United States. At least one study has estimated that nearly 50 percent of all drugs are not taken as prescribed. As a result an estimated $100 billion is spent annually on lost productivity and unnecessary medical costs, such as doctor visits, hospitalizations, and nursing-home admissions. A further study has estimated that noncompliance with prescription medications causes 125,000 deaths, annually.

In some instances, patient noncompliance may be unintentional. Complex medication regimens can sometimes confuse even the most alert of patients. However when coupled with reduced memory capacity like that resulting from dementia, mental illness, or even less severe natural degradations in mental facilities due to aging, patient compliance becomes that much more difficult.

In other instances, patient noncompliance may be intentional. Pain, for example from arthritis, or other physical impairments, like difficulty swallowing, can sometimes deter patients from taking their medication as prescribed. Sometimes a patient's self comparison of the perceived side effects versus the perceived benefits of taking prescribed medication may lead to a patient's voluntary medication noncompliance.

In those instances where the side effects are real, the side effects can sometimes be treated and/or minimized by supplementing the original prescription with an additional medication directed to dealing with the side effects experienced. However, any additional medications being prescribed can only contribute to the complexity of the patient's prescription medication regimen. Depending on how complex the patient's prescription regimen already is, a doctor may be reluctant to prescribe additional medications, especially where compliance issues may already exist.

Several systems have been developed for simplifying the complexity associated with taking multiple medications. However in many instances these systems impose a regimen which may include additional steps. For example, medications which are to be taken over a period of time can be organized into a tray, which includes multiple compartments, where each compartment is adapted to hold all the medications to be taken by the patient at a particular predetermined time. One of the potential drawbacks associated with a system of this type is the ability of the different medications to come into physical contact with one another prior to being taken. This allows different medications to potentially interact, where often times the potential effect is generally unknown.

In some instance it may be beneficial to limit or restrict the order in which the multiple medication components are to be dispensed. By controlling the order in which multiple medication components are dispensed, the specific dosage of a particular medication component could be altered during the duration of the prescribed regimen. This would allow, for example, the dosage of a particular medication component to be ramped up or ramped down at the beginning or the end of the prescribed period. This could be useful for instance, where a medication component is being taken to reduce the cravings while an individual is quitting an addictive habit, like smoking. In this instance, the dosage levels might be ramped down during the prescribed period.

In other instances the dosage may be tied to a periodic biological cycle of the person taking the medication, like in the case of at least one type of birth control medication.

Consequently, it would be beneficial to develop a packaging system by which multiple medications or medication components can be separately stored and dispensed together, and which reduces the burdens associated with taking the multiple medications or medication components as prescribed including simplifying the proper combination and administration of the multiple medication components, as well as the removal of the medication from the packaging.

Still further, it would similarly be beneficial to develop a packaging system, which controls the order in which several days worth of medication are taken. To allow for the controlled variations in the medication components, while minimizing the burdens associated with the proper sequencing of the disparate individual use groupings.

### SUMMARY OF THE INVENTION

A package system is provided for separately storing and dispensing together separate medication components. The package system includes a base sheet, which has a plurality of cavities for receiving multiple medication components, that are organized in per use groupings, and a cover sheet for captivating the multiple medication components in each of the corresponding cavities. The package system further includes an access shield having one or more openings, which is selectively oriented in one of a plurality of positions, where in each position at least one of the one or more openings are aligned with the cavities and the corresponding medication components of one of the per use groupings, and where the shield substantially restricts access to the medication components located in the non-aligned cavities.

In one aspect of the invention, the cover sheet is divided into multiple segments, where each of the segments covers the cavities corresponding to one of the per use groupings. In at least one instance each of the multiple segments corresponds to a portion of the cover sheet, which when a shearing force is applied to the cover sheet segment, the cover sheet segment separates from the base sheet and the other multiple segment portions of the cover sheet.

In another aspect of the invention, the access shield includes an armature, that is aligned with the one or more openings in the shield. When the armature is deflected towards the openings, the armature facilitates the breach of the cavities and the release of the one or more medication components located within the aligned cavities.

In a further aspect of the invention, the shield has a contact surface which engages a corresponding contact surface of the non-rotating elements of the package system. Interaction between the corresponding contact surfaces creates natural stop points during the rotation of the shield with respect to the non-rotating elements of the package system. In at least one instance, the contact surface includes a saw tooth surface, which substantially limits the rotation of the shield in one direction.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a top plan view of a package system with access shield, that includes multiple cavities for separately storing and dispensing together separate medication components, in accordance with the present invention;

FIG. 2 is an exploded isometric view of the package system, illustrated in FIG. 1, which illustrates as separately expanded, a base sheet, a cover sheet, and an access shield brought together to form a package system in accordance with the present invention;

FIG. 3 is a partial side view of the package system, illustrated in FIGS. 1 and 2, which shows the contact surfaces for the access shield engaged with the contact surface of the non-rotating elements of the package system including a saw-tooth arrangement for creating natural rotational stop points and for substantially restricting the rotation of the access shield in one direction;

FIG. 4 is a plan view of a saw tooth contact surface, illustrated in FIG. 3;

FIG. 5 is an alternative contact surface including multiple ridges spaced apart at 90 degree angles for engaging a saw tooth configuration of a corresponding contact surface;

FIG. 6 is an enlarged partial side view of a saw tooth contact surface illustrating several peaks and valley, where the contact surface on a first side of the each of the peaks is sloped at an angle that is nearly perpendicular to the non-contact surface portions of the package system;

FIG. 7 is an alternative enlarged partial side view of a saw tooth contact surface, where the contact surface on both sides of each of the peaks is sloped at an angle that is substantially less than perpendicular;

FIG. 8 is an isometric view of an armature for use in connection with the access shield in accordance with at least one embodiment of the present invention, shown in relation to the armature is a phantom outline of the other elements of the package system, shown in FIGS. 1 and 2;

FIG. 9 is a side view of the armature, illustrated in FIG. 8;

FIG. 10 is a bottom isometric view of an alternative armature embodiment incorporating a pair of cutting blades; and

FIG. 11 is a side isometric view of the alternative armature embodiment, illustrated in FIG. 10.

### DETAILED DESCRIPTION OF THE PREFERRED EMBODIMENTS

While the present invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

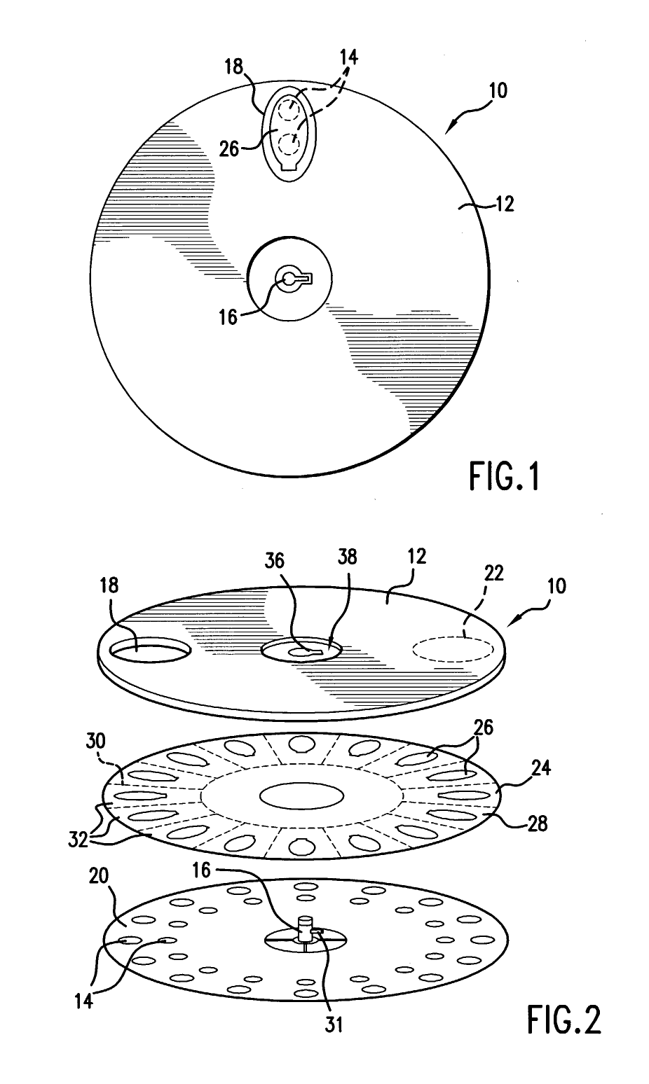

FIG. 1 illustrates a top plan view of a package system 10 incorporating an access shield 12. The package system includes a base sheet including multiple cavities 14 for separately storing and dispensing together separate medication components, in accordance with the present invention. The medication components are organized in per use groupings.

The access shield 12 is rotationally coupled to the package system 10 at a centrally located rotational pivot point 16. The access shield 12 includes an opening 18 through which the cavities 14 and the corresponding one or more medication components for a particular use grouping can be accessed dependent upon the rotational orientation of the access shield 12. The access shield 12 can be rotationally oriented in one of a plurality of positions, so as to align with and enable access to each of the use groupings. The access shield 12 substantially restricts access to the medication components located in the non-aligned cavities. In other words, access to the medication components in the non-aligned cavities through normal intended usage is restricted. This results in an access shield, which selectively allows access to some, but less than all, of the contained medication components at any given time.

As illustrated in FIG. 2, the cavities 14 are formed as part of a base sheet 20. In at least one embodiment the cavities 14 are blisters formed in a blister sheet. As noted previously, the cavities are organized in use groupings. In the illustrated embodiment, each of the use groupings consists of a pair of cavities located along a common radius of the package system 10, where the two different types of medication components are organized in concentric circles. However, there is no requirement that the medication components, which are located on a common arc or circle, that they be of the same type or of the same strength. Furthermore it is possible to organize the usage groupings in an arrangement, which does not coincide with a radius of the package system 10.

By way of example, medication components, that are grouped together in a common usage grouping, could also be located side by side, or clustered together in some other arrangement. One such arrangement could include the medication components and corresponding cavities of a common usage grouping, each being contained in a common wedge shaped section of the package system.

While the medication components for a common usage grouping in many instances would be physically located proximate to one another, such an organization is not required. For example, the access shield 12 could have a second opening 22 located across from the first opening 18 on the opposite side of the package system. In this instance, it would be possible for cavities located remote from one another to be commonly exposed, dependant upon the rotational orientation of the access shield 12.

Prior to the release and subsequent usage of the medication components, the medication components are sealed within their respective cavities 14 by a cover sheet 24. In at least one embodiment, the cover sheet 24 includes separate cover elements 26, which are adhered to a first layer 28 of the cover sheet 24. The cover elements 26 overlay openings in the first layer 28, which encompass the cavities 14 containing the medication components for a particular usage grouping. The cover elements 26 can be heat sealed or glued to the first sheet layer 28 using an adhesive that readily tears away when a shearing force is applied. For purposes of the present invention a shearing force is defined as a force, which includes a substantial component lateral to the normal direction of the holding force.

Alternatively, the cover sheet 24 could be divided into multiple segments, where each segment similarly corresponds to the cavities 14 containing the medication components for a particular usage grouping. Dashed lines 30 have been used to illustrate one possible arrangement of the different segment areas 32. The integrity of the material used to form the cover sheet 24 could be diminished along the dashed lines 30, thereby forming a weakened area or line, which facilitates the cover sheet 24 tearing along the lines 30 as a force is applied to a specific segment 32. Correspondingly, the specific segment 32 would be removed from the base sheet 20. This would substantially limit the other segments 32 being similarly separated from the base sheet 20, when the removal force is applied.

In at least one embodiment a weakened line or area could be made by scoring the material used to form the cover sheet 24. In at least another embodiment the cover sheet 24 could be perforated along the weakened line or in the weakened area. In yet a further embodiment, strands of strengthening fibers could be interrupted or diminished at the points where the weakened lines/areas are formed. In some instances, however, it may be inappropriate to use perforations for forming the weakened line/area, if the perforations would compromise the integrity of a seal, which might be important to maintain. In some instances it may be important to physically isolate or limit the exposure of a medication component, prior to usage, to other medication components and/or the external environment. Physical isolation can include protection from humidity, light and temperature differences.

Presumably, in at least some of the embodiments, the cover elements 26 or different segment areas 32, will have a portion which is at least partially unattached to either the base sheet 20, or the first layer 28 of the cover sheet 24. This will enable a user to establish an initial grip with which to apply a removal or shearing force.

Once the cover element 26 or the segment area 32 for a particular use grouping has been removed, the medication components contained within the corresponding cavities will be released for use.

By releasing the multiple medication components associated with a particular usage, together at the same time, much of the confusion associated with taking multiple medications is significantly diminished. This of course requires preplanning when the medication components are packaged with knowledge as to how and when the medication components are going to be used.

While in some instances the packaging system will be highly specific to a particular user, in other instances, where the likelihood of using two or more particular medication types together is relatively large, the anticipated volumes may warrant making such a prepackaged combination commonly available.

There are several instances where multiple medication components, which are stored separately, but are taken together, may be beneficial. These instances include situations, where the taking of two medication components together enhance the effectiveness of one or both of the medication components. Further instances include situations, where one of the medications is being used to eliminate or reduce a side effect of the other medication. In other instances it may be beneficial to keep the two components separate until just prior to use. In some instances complete physical isolation may be desirable, while in other instances it may be sufficient to prevent the two components from coming into physical contact with one another.

Several specific examples, where multiple medication components being used together is beneficial, includes the use of certain beta blockers like propranalol, atenolol, bisoprolol and metoprolol, with certain diuretics like hydrochlorothiazide and furosemide; the use of certain nonsteroidal anti-inflammatory drugs like ibuprofen, piroxicam, diclofenac, sulindac and indomethacin, with certain proton pump inhibitors like omeprazole and lansoprazole; the use of certain oral-diabetic agents like glyburide and glipizide along with metformin; and the use of certain anti-rejection drugs like cyclosporin and tacrolimus with certain types of steroids like prednisone. Various combinations of these types are well suited for use with the packaging system of the present invention.

In the illustrated embodiment, a spindle is illustrated to correspond to the pivot point 16 upon which the access shield 12 rotates. The spindle includes a key prong 34, which limits the rotational orientation of the access shield 12 with respect to the base sheet 20, when the two are initially brought together. The key prong 34 corresponds to a notch 36 in the access shield 12, where the two need to be aligned, when bringing the access shield 12 and the base sheet 20 together. Once the two have been brought together, a depression 38 proximate the center of the access shield 12, enables the access shield 12 to be rotated unobstructed by the key prong 34.

By controlling the rotational orientation of the access shield 12 with respect to the base sheet 20 when the two are brought together, the initial alignment of a specific usage grouping with the openings 18 in the access shield 12 is insured. This can be used to assist in the distribution of medication components in a particular sequence. The proper sequence can be further assisted by insuring that the access shield can be rotated in only a single direction, thereby insuring the proper order in which the medication components are taken.

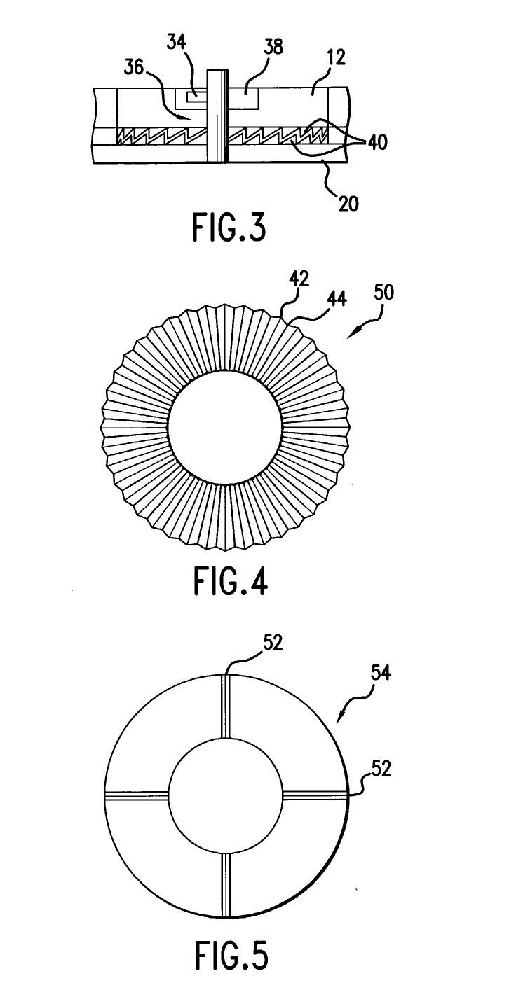

One method for substantially limiting the rotation of the access shield 12 in a single direction includes the use of mating saw tooth shaped surfaces 40. One such example is illustrated in FIG. 3.

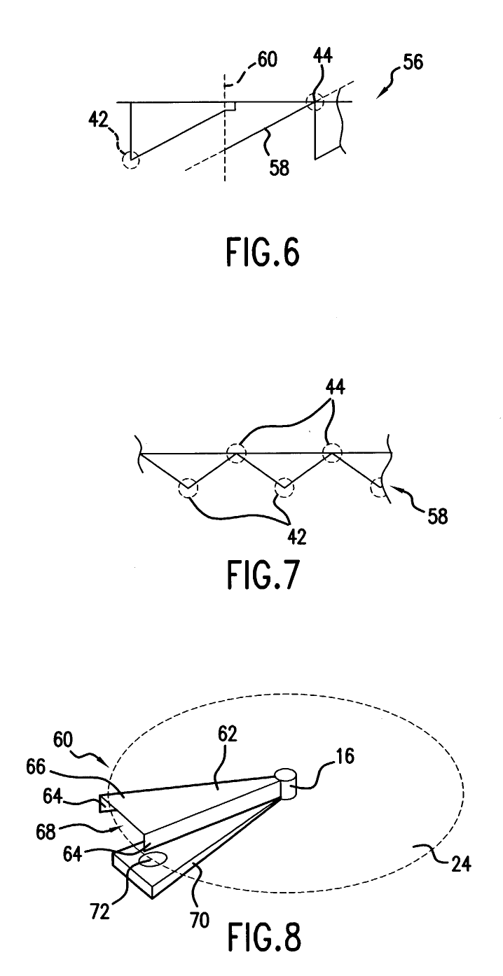

Generally, the saw tooth surface creates a ratchet effect, that limits the unintended rotational migration of the respective elements, thereby creating natural stop points. The saw tooth surface includes multiple peaks 42 and valleys 44, which can be better seen in FIGS. 6 and 7. The peaks 42 or ridges from one of the mated surfaces are biased, so as to rest within the valleys 44 of the other corresponding mated surface.

Generally, a force needs to be applied to cause the peak of the first surface to lift out of the respective valley of the second surface, to then traverse an opposing peak of the second surface, and then to settle back down into the next adjacent valley of the second surface. The amount of force required is dependent upon the height differential between the valleys and the peaks, and the angle of the slope connecting the valleys to the peaks. Generally, the steeper the slope, the larger the amount of force required to traverse the peak. Where a slope is substantially perpendicular to the direction of rotational movement, the movement in that direction can typically be substantially restricted.

FIG. 4 illustrates a plan view of one example of a contact surface 50 including a saw tooth surface. Generally, the peaks 42 and valleys 44 do not extend all the way toward the center. This provides spacing for the pivot point 16 and the key prong 34 to be able to rotate unobstructed.

While it is possible for both surfaces to include a full saw tooth surface, as illustrated in FIGS. 3 and 4, in some instances the second contact surface may include a reduced number of peaks or may include ridges 52, as shown in connection with the contact surface 54, illustrated in FIG. 5. The reduced number of ridges 52, often times makes it easier to properly align and/or maintain registration with the peaks 42 and valleys 44 of the corresponding saw tooth contact surface 50.

FIG. 6 illustrates an enlarged partial side view of a saw tooth contact surface 56. As noted previously the saw tooth contact surface includes a plurality of peaks 42 and valleys 44. However, whereas the slope 58 of the contact surface on the right side of each of the peaks is substantially less than perpendicular with respect to the non-contact surface portions of the package system 10, the slope 60 of the contact surface of the left side of each of the peaks is substantially perpendicular.

As a result the peaks or ridges of the corresponding contact surface, which generally resides within one of the valleys 44 of the saw tooth contact surface 56, will find it easier to traverse a peak 42 located to the left, than it is to traverse a peak 42 located to the right of the valley 44 in which it resides. In effect, rotational movement is substantially limited to the one direction. By incorporating such a saw tooth contact surface 56 configuration in combination with the use of a key prong 34, a packaging system which not only dispenses multiple medication components simultaneously is provided, but a packaging system which assists the user as to the proper sequence in which the individual medication component groupings are to be used is provided.

FIG. 7, illustrates an alternative saw tooth contact surface 58, which incorporates a contact surface on both sides of the peaks, which are substantially less than perpendicular. Consequently, rotation of the access shield 12 in both directions is generally possible.

FIG. 8 illustrates an isometric view of a further alternative embodiment, where the access shield 12 further incorporates an armature 60 for use in extracting the medication components from the aligned cavities 14. In the illustrated embodiment the armature includes two sections, a top armature portion 62, and a bottom armature portion 70, which together generally straddle the base sheet 12 and the corresponding cover sheet 24.

The top armature portion 62 includes two side walls 64 and a cross member 66, which in combination with the surface of the cover sheet 24 form a chute through which released medication components can travel. At the end of the chute, which coincides with the outer circumference of the package system, is a common aperture 68 through which the released medication components can exit.

The bottom armature portion 70 includes one or more protrusions 72, which as illustrated in FIG. 9, correspond to the location and arrangement of the cavities 14 within the base sheet 12. Both the top armature portion 62 and the bottom armature portion 70 taper and meet near the rotational pivot point 16 of the package system 10. The medication components are released from their respective cavities 14, i.e. pushed through the cover sheet and out of the cavity by protrusions 72, when the top 62 and bottom 70 armature portions of the armature 60 are deflected together. In this instance, the cover sheet could be made from a material like aluminum, which will readily be pierced, when such a force is applied. Additionally, the cavities would need to be made from a material which will readily deflect.

As illustrated in FIG. 9, both the top 62 and/or the bottom 70 armature portions can be biased apart by one or more springs 74.

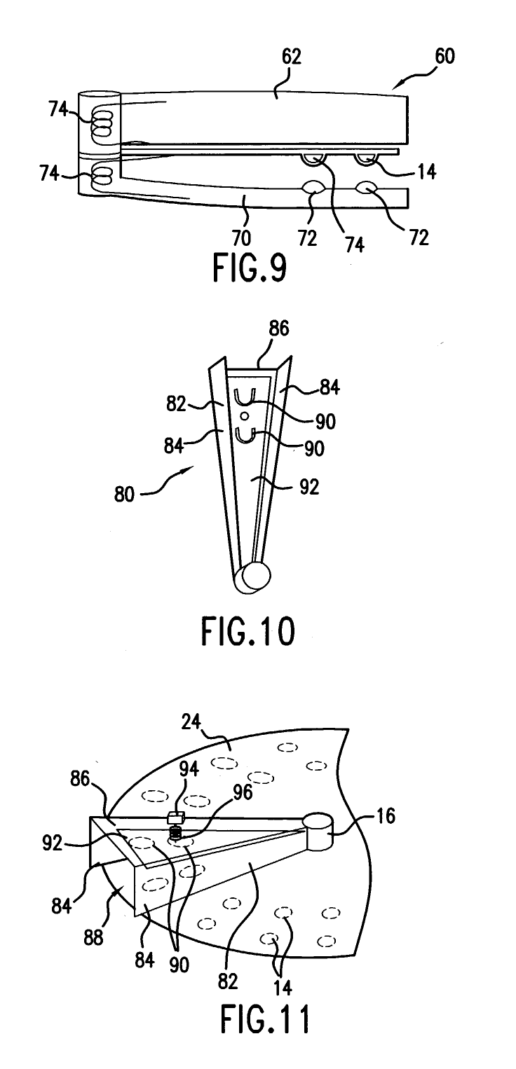

FIGS. 10 and 11 illustrate an alternative armature 80, which instead of making use of both a top and a bottom portion, only includes a top portion 82. Similar to the top portion 62 of armature 60, illustrated in FIGS. 8 and 9, the top portion 82 of armature 80 includes two side walls 84 and a cross member 86, which in combination with the surface of the cover sheet 24 form a chute through which released medication components can travel. Similarly, at the end of the chute, coinciding with the outer circumference of the package system, is a common aperture 88 through which the released medication components can exit.

However, instead of including a bottom portion, which pushes the medication components through the corresponding portion of the cover sheet 24, armature 80 includes one or more cutting blades 90 attached to a deflectable surface 92. A push button 94, which extends through the cross member 86, is coupled to the deflectable surface 92. When the push button 94 is depressed, the deflectable surface 92 is pressed toward the cover sheet 24. The blades 90 are located, along the deflectable surface 92, so as to correspond to the cavities 14 located in the base sheet 12. As a result, the blades will cut into the portions of the cover sheet 24 captivating the medication components within the corresponding cavities 14. The medication components are then released into the chute, where they can exit via the aperture 88. When the push button 94 is not being pressed, a spring 96 biases the push button 94 and the deflectable surface 92 toward a non-deflected position.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A package system for separately storing and dispensing together separate medication components comprising:
a base sheet including a plurality of cavities for receiving multiple medication components organized in per use groupings;
a cover sheet for captivating the multiple medication components in each of the corresponding cavities; and
an access shield having one or more openings, which is selectively oriented in one of a plurality of positions, where in each position the at least one of the one or more openings are aligned with the cavities and the corresponding medication components of one of the per use groupings, and where the shield substantially restricts access to the medication components located in the non-aligned cavities.

2. The package system in accordance with claim 1 wherein the cavities in the base sheet are blisters in a blister sheet.

3. The package system in accordance with claim 1 wherein the package system has a shape, which is substantially circular.

4. The package system in accordance with claim 1 wherein the cavities are arranged in one or more arcs or concentric circles.

5. The package system in accordance with claim 4 wherein the medication components for each of the per use groupings are located along a common radius of the largest of the one or more arcs or concentric circles.

6. The package system in accordance with claim 4 wherein the medication components for each of the per use groupings are located in a common wedge shaped portion of the largest of the one or more arcs or concentric circles.

7. The package system in accordance with claim 4 wherein the access shield is rotatably coupled to the package system proximate the center of a least one of the one or more arcs and concentric circles.

8. The package system in accordance with claim 7 wherein the shield is keyed so as to be initially coupled to the package and a specific rotational orientation.

9. The package system in accordance with claim 7 wherein the shield has a contact surface which engages a corresponding contact surface of the non-rotating elements of the package system, which creates natural stop points during the rotation of the shield.

10. The package system in accordance with claim 9 wherein at least one of the contact surfaces has a saw tooth shaped surface including a plurality of peaks and valleys.

11. The package system in accordance with claim 10 wherein at least one of the contact surfaces has one or more ridges which bias the rotational orientation of the shield with respect to the non-rotating elements of the package system, so that the one or more ridges rest in the valleys of the contact surface having a saw tooth shaped surface.

12. The package system in accordance with claim 10 wherein the portion of the saw tooth shaped contact surface on a same first side of each of the peaks is sloped at an angle, which is nearly perpendicular to the non-contact surface portions of the package system, and wherein the portion of the saw tooth shaped contact surface on a same second side of each of the peaks is sloped at an angle, which is substantially less than perpendicular to the non-contact surface portions of the package system.

13. The package system in accordance with claim 12 wherein at least one of the contact surfaces has one or more ridges which bias the rotational orientation of the shield with respect to the non-rotating elements of the package system, so that the one or more ridges rest in the valleys of the contact surface having a saw tooth shaped surface, and wherein the nearly perpendicular slope of the first side of the peak in the saw tooth shaped contact surface limits the rotation of the shield in a direction which would cause the ridge to traverse the peak of the saw tooth surface from the first side of the peak having the nearly perpendicular slope.

14. The package system in accordance with claim 1 wherein the shield includes an armature aligned with the one or more openings in the shield which when deflected towards the openings releases the medication components located within the aligned cavities.

15. The package system in accordance with claim 14 wherein the armature includes one or more blades which cut into the cover sheet corresponding to the aligned cavities, when the armature is deflected.

16. The package system in accordance with claim 14 wherein the armature includes one or more protrusions, which push the contents of the cavity through the cover sheet, when the armature is deflected.

17. The package system in accordance with claim 14 wherein the armature includes a passage with a common aperture through which the medication components travel when released.

18. The package system in accordance with claim 1 wherein the cover sheet is divided into multiple segments, where each segment covers the cavities corresponding to the same per use grouping.

19. The package system in accordance with claim 18 wherein the multiple segments of the cover sheet are formed by the inclusion of area or lines of weakness in the cover sheet along which the cover sheet is more likely to tear or separate.

20. The package system in accordance with claim 18 wherein when the access shield is aligned with the cavities and the corresponding medication components of one of the per use groupings, the corresponding cover sheet segment is exposed thereby allowing the exposed segment of the cover sheet to be removed.

21. The package system in accordance with claim 19 wherein the exposed segment of the cover sheet is removed by the user applying a shearing force to the segmented portion.

22. The package system in accordance with claim 1 wherein the per use groupings are arranged in the order in which the per use groupings are used.

23. The package system in accordance with claim 1 wherein, prior to the removal or breakage of the corresponding portion of the cover sheet, the medication components located in each one of the cavities is substantially physically isolated from the environment outside of the package system including protection from at least one of humidity, light, and temperature.
